(19) United States
(12) Patent Application Publication
(10) Pub. No.: US 2006/0004824 A1
(43) Pub. Date: Jan. 5, 2006

(54) IPMI VALIDATING SYSTEM AND METHOD

(76) Inventors: Chih-Tao Hsieh, Taipei Hsien (TW); Chun-Te Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,524

(22) Filed: Jul. 19, 2004

(30) Foreign Application Priority Data
May 24, 2004 (TW) 093114847

(51) Int. Cl. G06F 17/00

(52) U.S. Cl. 707/102

(57) ABSTRACT

An IPMI validating system and method are optimally used between a host system having an IPMI, and an operating terminal. The validating system includes a user interface, an IPMI command engine module, an IPMI command management unit and a channel management unit. The IPMI command engine module is capable of directly encoding a test program into an IPMI command, rather than using the prior art ICTS and TCL/TK that connects with several libraries, modules and configuration files, and encoding an ICTS framework manager and test module together into IPMI commands. Therefore, the validating system provides a higher performance efficiency and readability for IPMI thereby raising validating efficiency.

### BACKGROUND OF INVENTION

1. Field of the Invention

The present invention relates to an intelligent platform management interface (IPMI) validating system and method, and more particularly, to an IPMI validating system and method used in server management.

2. Description of the Prior

As known in the art, when remote servers, such as telecommunication equipment or computer stations and especially ISP servers, are out of order, a system manager must go to the servers location to fix the breakdown. This requires a lot of manpower and time. To solve this issue, management technology for remote servers, such as an intelligent platform management interface (IPMI), has gradually been developed.

The IPMI mainly comprises a micro-controller having a baseboard management controller (BMC) and firmware embedded in the BMC. The IPMI controls the management software of the system and the interface between the platform and the hardware. Moreover, the IPMI can operate in different firmware and hardware platforms at the same time. The IPMI automatically provides the system status detection of software/hardware of the servers, event diary log, rebooting system control functions, and automatic alarm for the event and auto-system control (such as failure of power). For instance, an I²C digital sensor connected to the IPMI can detect real time extraordinary system voltage, temperature and fan speed of the fan in the remote server and determine if the detecting data is out of a predetermined range. In addition, the IPMI makes it convenient for the system manager to remotely monitor the servers through a local area network (LAN) or a serial modem to receive the detecting data. When a critical event occurs, the system manager can execute fault correction immediately. For an example, if the temperature of the server is over the predetermined range, the speed of the fan is immediately increased to eliminate heat. If the condition is critical, in addition to data being recorded for future inquiry, the system manager, who is far from the server, will be informed through the LAN.

However, IPMI of different manufacturers, including the hardware and firmware, have different efficiencies. Therefore, an IPMI conformance test suite (ICTS) software is utilized for executing a pass-fail test to determine whether the IPMI is compatible with each hardware/software environment in different servers, such as BIOS, firmware, windows, LAN, bus, and CPU. The structure and flowchart of the pass-fail test is shown in FIG. 1, including an ICTS framework manager, an ICTS utility library, a message routing library, and a set of transport API. The ICTS framework manager generates a GUI menu to control a TCL/TK test module to validate the IPMI. The ICTS utility library provides ICTS functions. The message routing library provides IPMI message functions. The transport API is connected to an assigned channel for transmitting an IPMI command.

As shown in FIG. 1, when a prior art ICTS is required to execute a loaded TCL/TK test module (step S100) to validate the IPMI, the ICTS should be connected to a TCL/TK engine outside the ICTS (step S122), configuration files of each system (step S110), transport modules inside the ICTS (step S134), and each library (step S114 and S132). The TCL/TK engine, the TCL/TK test module, and the ICTS framework manager are written in the TCL/TK language; therefore, the TCL/TK engine first combines the TCL/TK test module and the ICTS framework manager to be encoded into IPMI commands so as to validate the IPMI, as shown in step S120. In addition, a part of the TCL/TK engine and the configuration files not belonging to the ICTS must be loaded in a computer of a user (the validating terminal) before the ICTS is loaded. The transport modules and libraries are first written according to the requirement and then compiled. The procedure is complicated.

Sometimes the test scope provided by the ICTS mentioned above is too small, not including the entire IPMI and the hardware/software environment in the servers, or not satisfying a particular test demand of the system manager. Therefore, if the system manager wants to expand or modify the test scope or functions of the ICTS, a test module should be rewritten, transformed with the ICTS framework manager by the TCL/TK engine and executed, as shown in step S120. Otherwise the libraries provided to each test module, such as the ICTS utility library, must be rewritten in advance.

However, if the system manager wants to write the test module by himself, first they have to know the entire structure of the IPMI and IPMI commands and learn the TCL/TK language. However, the TCL/TK commands are not developed according to the ICTS. Thus the usage of commands is complex and the efficiency of the program for the IPMI is not adequate. What is worse, the system manager is not used to the TCL/TK script language, and therefore, the system manager must learn the new language for the operation of validation. This wastes time and is likely not possible during critical situations.

In step S120, the TCL/TK test module must be connected to the ICTS framework manager to be executed; therefore, if a significant modification is required in the future, the current test module might not work. A new test module should be rewritten and it is not convenient to use the TCL/TK commands in the ICTS.

Moreover, the design of the ICTS is also too complicated. For instance, when validating each test module, the ICTS should be connected to each module/library according to different demands, the TCL/TK engine, the ICTS framework manager, the configuration files, and the libraries. This requires different layer programs and reduces the execution efficiency of the ICTS. Therefore, if a new and better structure of the ICTS could be provided, the execution efficiency of the ICTS will be increased and thus the efficiency of validating the IPMI will be improved.

### SUMMARY OF INVENTION

It is therefore a primary objective of the claimed invention to provide an IPMI validating system and method to solve the above-mentioned problems.

It is an advantage of the claimed invention that a new and easier manager structure is provided. The claimed invention comprises an IPMI command engine module, an IPMI command management unit, and a channel management unit. The claimed invention does not have to use the prior ICTS and the TCL/TK engine. For execution, the IPMI command engine module of the claimed invention is a translator for programs and can directly encode a test program into an IPMI command. Moreover, the claimed invention utilizes a new script language with simplified instruction set for easily learning and writing into a test program. Differently from the prior art, the claimed invention is implemented without the need that the prior art TCL/TK engine has to be connected to different libraries, transport modules, and configuration files, then transformed with the ICTS framework manager and the test program into an IPMI command. Therefore, regarding the performing efficiency of transforming program and the readability for the IPMI, the claimed invention is better than those in the prior art ICTS thereby raising the entire IPMI validating efficiency.

It is another advantage of the claimed invention that the method comprises generating a menu by a user interface for increasing the test scope by way of providing an open mode item that allows the user to load a predefined test program that can be modified at any time, and a selection mode item that gave access to a plurality of selectable default test programs, such as a system event log (SEL) or watchdog test program, for directly loading one of the test programs to quickly validate the IPMI.

Moreover, another advantage of the claimed invention is that a menu generated by a user interface can automatically provide the user with at least an available channel item to assign. Thus the claimed invention makes it convenient for a system manager to manage each validating condition.

To achieve the purpose mentioned above, the present invention provides an IPMI validating system optimally used between a host system having an IPMI and an operating terminal. The IPMI validating system comprises a user interface, an IPMI command engine module, an IPMI command management unit, and a channel management unit. The user interface generates output of a frame having a plurality of menus with optional items via the operating terminal. One of the menus includes an open mode item for allowing the user to load a defined test program and modify it at any time for expanding the test scope, and at least one selection mode to facilitate loading a default test program from a test program area 212 for immediately validating the IPMI. The IPMI command engine module can directly encode the loaded test program into an IPMI command and execute the IPMI command. Next, the IPMI command management unit receives the IPMI command and transmits the IPMI command to a channel assigned by the user. The available channels are first shown on the user interface for the user to assign. The channel management unit is located in a protocol layer having a plurality of channel protocol conversion elements. The channel management unit transforms the IPMI command into a message conforming to the assigned channel protocol according to the assigned channel, and then sends the message to the IPMI of the host system for validation.

In addition, the present invention further provides an IPMI validating method used between a host system having an IPMI and an operating terminal. The method comprises loading a defined test program to be modified or loading a default test program for immediately validating the IPMI, providing at least one available channel by the user interface for the user to assign, encoding the loaded test program into an IPMI command by an IPMI command engine module and executing the IPMI command, receiving the IPMI command and transmitting it to a channel assigned by the user, transforming the IPMI command into a message conforming to the assigned channel protocol according to the assigned channel by a plurality of channel protocol conversion elements, transmitting the message to the IPMI of the host system through the assigned channel for validation, and sending a corresponding validation result by the IPMI through the assigned channel and presenting the result on the user interface for the user to browse and save the result.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows the prior art ICTS flowchart and structure.

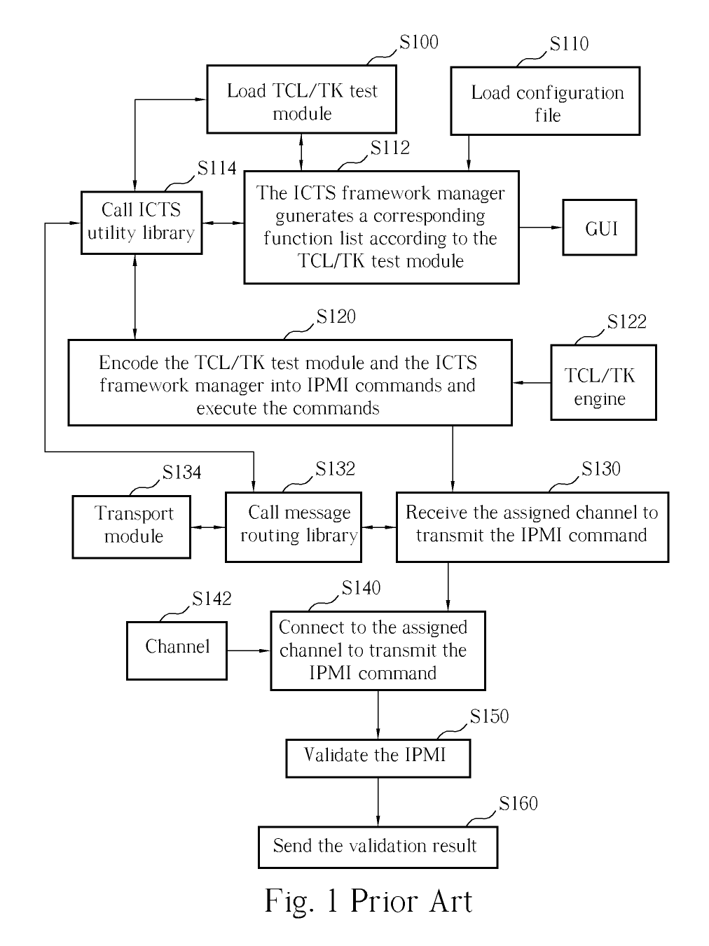

FIG. 2 is a diagram of the present invention IPMI.

FIG. 3 is a flowchart of operation of the present invention IPMI.

### DETAILED DESCRIPTION

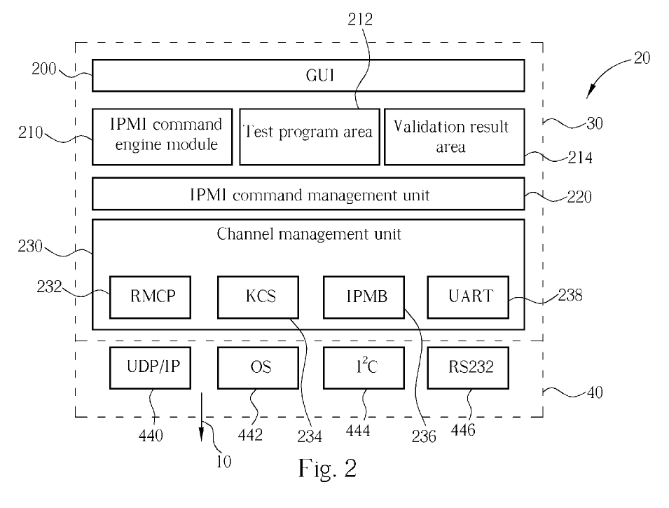

First referring to FIG. 2. FIG. 2 is a diagram of the present invention IPMI validating system 30. The IPMI validating system 30 is optimally used between a host system 10 having an IPMI and an operating terminal 20. The operating terminal 20 is a remote or near computer and electrically connected to the host system 10 through a network system, such as LAN, or a connection, such as an RS232 port. A transport interface layer 40 is formed at the operating terminal 20 and includes several kinds of interfaces, such as a UDP/IP protocol interface 440 and an RS232 protocol interface 446, or a driver software interfaces, such as an OS program interface 442 and an I²C driver software interface 444. All of these interfaces communicate with the present invention IPMI validating system 30 via a channel for transmitting IPMI messages therebetween.

The IPMI validating system 30 mainly comprises a graphical user interface (GUI) 200, an IPMI command engine module 210, an IPMI command management unit 220 and a channel management unit 230. The GUI 200 generates output of a frame having a plurality of menus with optional items via the operating terminal 20. One of menus includes an open mode item for allowing the user to load a predefined test program and then modify it at any time for broadening the test scope, and at least one optional mode item to facilitate loading a default test program from a corresponding test program area 212 for immediately and fast validating the IPMI. The default test programs include a system event log (SEL) test program, a watchdog test program, a sensor data record (SDR) test program, a chassis test program and a field replaceable unit (FRU) test program. Moreover, the GUI 200 can provide at least one channel item for the user to assign. For instance, a frame having “KCS”, “LAN”, “IPMB” and “Serial/Basic” items is generated in the GUI 200, which give access to KCS, RMCP, IPMB and UART channels shown in FIG. 2.

Note that differently from the prior art TCL/TK script language, the present invention uses a new script language with simplified instruction set which is easier to learn and draft into the test program for newborn operator. It is convenient for the operator to use simplified commands to write any test program at the windowed frame of the GUI 200.

The IPMI command engine module 210 is a script language translator for the simplified instruction set and directly encodes the loaded test program into an IPMI command and executes the IPMI command. Such an IPMI command is a machine code.

Next, the IPMI command is received by the IPMI command management unit 220 and transmitted to a channel assigned by the user. For instance, the user selects a “LAN” item in advance.

The channel management unit 230 is located at a protocol layer, having a plurality of channel protocol conversion elements, such as a remote management control protocol (RMCP) element 232, an intelligent platform management bus (IPMB) protocol element 236, a keyboard control style interface (KCS) protocol element 234, and a universal asynchronous receiver/transmitter (UART) protocol element 238. Each protocol element substantially can correspond to one of the corresponding channel items appearing in the menus. For examples, a “LAN” item corresponds to the RMCP element 232; a “IPMB” item corresponds to the IPMB protocol element 236; a “KCS” item corresponds to the KCS protocol element 234; and a “Serial/Basic” item corresponds to the UART protocol element 238. Therefore, each one of the channel protocol conversion elements of the channel management unit 230 would transform the IPMI command into a corresponding message conforming to the assigned channel protocol, such as RMCP protocol 232, according to the assigned channel item such as LAN. Then the message is transmitted from the transport layer 40, such as UDP/IP 440, to the IPMI of the host system 10 for validation. In addition, the IPMI will send a validation result back along the same channel protocol, such as RMCP 232. The validation result is presented in a special output form via the GUI 200 for the user to browse or save in a validation result area 214.

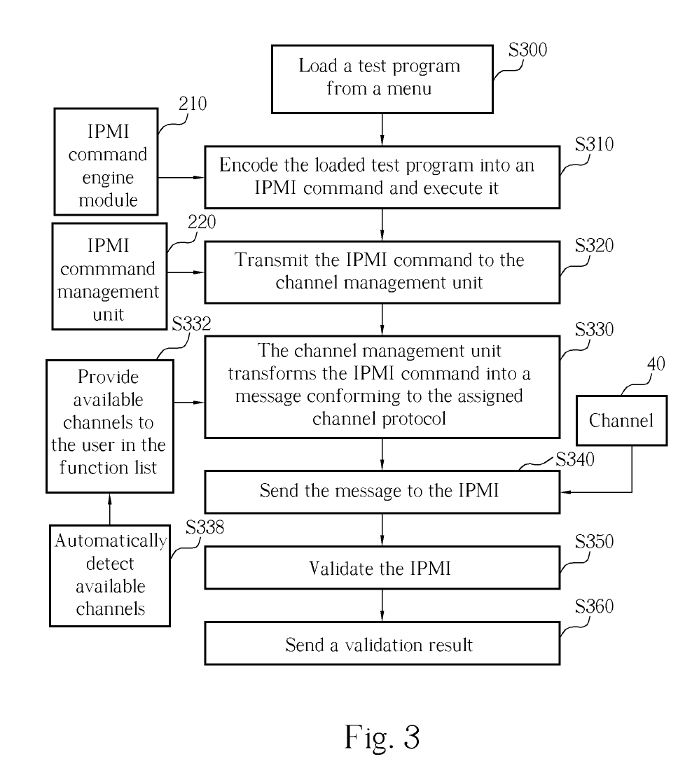

In addition, FIG. 3 is a flowchart of operation of the present invention IPMI optimally used between a host system having an IPMI and an operating terminal. The steps are as follows:

In Step S300, the user can load a predefined test program to modify or load a default test program to validate the IPMI at the GUI 200 of the operating terminal 20.

In Step S310, the IPMI command engine module 210 directly encodes the loaded test program into an IPMI command and executes the IPMI command.

In Step S320, get the IPMI command and transmit it to the assigned channel.

In Steps S330, S332 and S338, the GUI 200 automatically provides the user with at least one available channel item to assign, such as “LAN”. Next, according to the assigned channel item “LAN”, the IPMI command is transformed into a message conforming to the assigned channel protocol such as RMCP 232, by means of the channel protocol conversion elements of the channel management unit 230.

In Steps S340 and S350, the message is transmitted, from the transport channel layer 40 of the operating terminal 20, such as UDP/IP 440, to the IPMI of the host system 10 through the assigned channel LAN for validation.

Step S360: the IPMI sends a corresponding validation result back according to the same channel protocol RMCP 232. The validation result is presented in a special output form via the GUI 200 for the user to browse and save in a validation result area 214.

Differently from the prior art, the IPMI validating system and method according to the present invention utilizes a new and simple management structure. The IPMI command engine module 210 can directly encode the test program into an IPMI command. In addition, the present invention adopts a simple instruction set so that learning the script language and writing the test program can be done quicker and easier. Therefore, the present invention is an improvement over the prior art ICTS and the TCL/TK engine, which must be connected to different libraries, the transport modules and the configuration files, then combined with the ICTS framework management and the test program to be transformed into the IPMI command. Thus, the validating system 30 of the present invention provides a higher performance efficiency and readability for IPMI thereby raising validating efficiency.

Those skilled in the art will readily observe that numerous modifications and alterations of the device may be made while retaining the teachings of the invention. Accordingly, the above disclosure should be construed as limited only by the metes and bounds of the appended claims.

1. An intelligent platform management interface (IPMI) validating system optimally used between a host system having an IPMI, and an operating terminal, the IPMI validating system comprising:
a user interface generating output of a frame having a plurality of menus with optional items via the operating terminal wherein at least one of the optional items allows a user to load a test program for validating the IPMI;
an IPMI command engine module capable of directly encoding the loaded test program into IPMI commands and executing the IPMI commands;
an IPMI command management unit receiving the IPMI commands and transmitting each IPMI command to a channel assigned by the user; and
a channel management unit having a plurality of channel protocol conversion elements for transforming the IPMI command into a message conforming to the assigned channel and sending the message to the IPMI of the host system for validation.

2. The IPMI validating system of claim 1 wherein one of the menus generated by the user interface includes at least an open mode item for allowing the user to load a predefined test program, and an optional mode item for loading a default test program to implement fast validation.

3. The IPMI validating system of claim 1 wherein the user interface further provides at least one channel item for the user to assign.

4. The IPMI validating system of claim 2 wherein the default test program includes a system event log (SEL) test program, a watchdog test program, a sensor data record (SDR) test program, a chassis test program and a field replaceable unit (FRU) test program.

5. The IPMI validating system of claim 1 wherein the IPMI command engine module is a compiled execution file written in a Delphi programming language.

6. The IPMI validating system of claim 1 wherein the channel protocol conversion elements include at least a remote management control protocol (RMCP) element, an intelligent platform management bus (IPMB) protocol element, a keyboard control style interface (KCS) protocol element, and a universal asynchronous receiver/transmitter (UART) protocol element.

7. An intelligent platform management interface (IPMI) validating method optimally used between a host system having an IPMI and an operating terminal, the IPMI validating method comprising:
loading a test program from a menu generated by a user interface at the operating terminal to validate the IPMI;
encoding the loaded test program into an IPMI command by an IPMI command engine module and executing the IPMI command;
receiving the IPMI command and transmitting the IPMI command to a channel assigned by a user;
transforming the IPMI command into a message conforming to the protocol of the assigned channel by one of a plurality of channel protocol conversion elements; and
sending the message to the IPMI of the host system through the assigned channel for validation.

8. The IPMI validating method of claim 7 further comprising loading at least one default test program by selecting a default item for validation.

9. The IPMI validating method of claim 7 further comprising the user interface providing at least one available channel item for the user to assign.

10. The IPMI validating method of claim 8 wherein the default test program includes a system event log (SEL) test program, a watchdog test program, a sensor data record (SDR) test program, a chassis test program and a field replaceable unit (FRU) test program.

11. The IPMI validating method of claim 7 wherein the channel protocol conversion elements include at least a remote management control protocol (RMCP) element, an intelligent platform management bus (IPMB) protocol element, a keyboard control style interface (KCS) protocol element, and a universal asynchronous receiver/transmitter (UART) protocol element.

12. The IPMI validating method of claim 7 further comprising sending a corresponding validation result back from IPMI along said assigned channel to the user interface for output browsing and storing the result.
